(19) United States
(12) Patent Application Publication
(10) Pub. No.: US 2019/0062144 A1
(43) Pub. Date: Feb. 28, 2019

(54) Cannabis Extract Dispensing System

(71) Applicant: Vireo Health LLC, Minneapolis, MN (US)

(72) Inventors: Eric Greenbaum, New York, NY (US); Kyle Kingsley, Minneapolis, MN (US)

(73) Assignee: Vireo Health LLC, Minneapolis, MN (US)

(21) Appl. No.: 15/484,079

(22) Filed: Apr. 10, 2017

Related U.S. Application Data
(60) Provisional application No. 62/320,564, filed on Apr. 10, 2016.

(51) Int. Cl. B67D 7/74

(52) U.S. Cl. CPC B67D 7/74

(57) ABSTRACT

A custom cannabis extract dispenser for dispensing a cannabis extract into a container is provided. The custom cannabis extract dispenser includes several reservoirs for containing the various ingredients that will make up the final extract. The ingredients include purified cannabinoids, namely THC, CBD, minor cannabinoids, and various flavorants. A fluid management system in communication with a computer controller enables a user to select the amounts of the various ingredients desired in a custom cannabis extract.

### STATEMENT REGARDING FEDERALLY SPONSORED RESEARCH

N/A

### FIELD OF THE INVENTION

The present invention relates generally to cannabis extract dispensing systems and methods and particularly relates to a cannabis extract dispenser for providing a number of different cannabis extract alternatives.

### BACKGROUND OF THE INVENTION

Cannabis extracts have risen in popularity as medical and recreational cannabis has proliferated. Depending on the use for which the extract will be used by the customer, different ratios of cannabis constituents will be desired. There is currently no way to provide individual quantities of customized cannabis extracts to meet individual consumer desires.

### SUMMARY OF THE INVENTION

As specified in the Background Section above, there is a need in the art to develop new cannabis extract dispensing systems.

Thus According to an embodiment of the present invention there is provided a cannabis extract dispenser for providing a number of different cannabis extract alternatives. The present application describes a cannabis extract dispenser (“CED”). In embodiments, the CED includes at least one major cannabinoid ingredient source, a flavorant source, optionally a diluent source, at least one dispensing nozzle, at least one pump/metering device, and a user interface. The user interface receives a request for a product type/formulation and instructs the pumps/metering devices to dispense a cannabinoid formulation specified by the customer.

An embodiment of the present invention is a CED comprising a plurality of storage reservoirs for storing a plurality of ingredients, a fluid transport system for transporting ingredients, a user interface for enabling users to input selections/instructions to the CED, a computing device for processing user input and communicating dispensing instructions to the CED.

Another embodiment is a method for providing a custom cannabis extract formulation comprising providing a cannabis extract dispenser further comprising a plurality of suitably stored cannabis ingredients, flavorants, and excipients, providing a user interface allowing users to select what ingredients and in what proportions they desire them in the extract, and dispensing the extract comprising the user's selection to the user.

Another embodiment is a method for assessing user preferences with respect to cannabis extracts comprising providing a cannabis extract dispenser further comprising a user interface allowing users to select what ingredients and in what proportions they desire them in their extract, a database operatively connected to the cannabis extract dispenser which stores the extract recipes created by users, a data analysis module that queries the extract recipes created by users and identifies trends in recipe creation.

Another embodiment is a method for determining the effects of various cannabinoids and cannabis extract formulations comprising allowing users to select/create cannabis extracts containing different ingredients, dispensing said extracts to users, allowing the users to administer the cannabis extract formulations, querying the users with respect to the effects of the extract formulations, correlating the various extracts and extract ingredients with reported effects. The method may further include making recommendations about specific extracts/extract ingredients to users who desire specific effects.

A CED and methods of dispensing a cannabis extracts are described. An embedded computer interface that allows customers to select and purchase a wide variety of cannabis extract combinations is utilized. The CED dispenses cannabis extracts that may be made from pure cannabis based extracts or an extract that is diluted to a desired concentration in a desired diluent or excipient. The CED may dispense predetermined extract mixtures or fully/partially customized extract formulations designed by the customer. Extract ingredients will generally be stocked in the CED in reservoirs. Each CED holds a plurality of separate ingredients. Generally, ingredients will include at least the major cannabinoids (THC and CBD), and a plurality of terpenes/terpenoids/volatiles. Additional ingredients may include the minor cannabinoids, other natural plant extracts, other flavorings, and the like.

A human user may approach the CED and present identification. In states in which cannabis is only legal for medicinal uses, the identification may comprise providing proof of proper registration with the appropriate authorities, such as, for example by presenting a registration card. In states in which cannabis use is legal for ‘adult use’ the identification may comprise providing proof of age. The step of providing identification may be facilitated by an operator that is authorized to validate the user's identification and may require an authorizing input on the part of the operator. Operators may be employees of the dispensaries or other locations where the CED is located. Once properly identified the CED pulls up that user's account. If desired the user may add funds through the CED with physical currency or bill the amount necessary using a credit card or other form of electronic payment. The CED may also pull up a list of that user's favorite or recently dispensed extracts or suggestions for extract formulations the user might like based on previous purchases or desired effects. The user can then order from this list, a standard extract formulation list, a favorite, or top selling formulations, recommended formulations, or design a totally new extract formulation. In designing a new custom extract formulation, the user may select a cannabinoid base such as pure THC, pure CBD, THC and CBD at various ratios, strain specific oils or the like, the user can then select flavorants such as cannabis derived volatiles, terpenes, terpeniods, and/or other flavorants such as lavender, rosemary, fruit flavorings and the like, and vary the intensity of the flavorants. For example the user could select at 1:1 THC to CBD base, 33% limonene, 33% myrcene, and 33% lavender, and then select the intensity of the flavor from extra-light to heavy. The user may also select other ingredients such as other plant/botanical extracts or other ingredients such as, for example, nicotine, vitamins or supplements. Next the user may optionally select a diluent/excipient such as MCT, vegetable glycerin, or the like and specify the final concentration of cannabinoids, for example a 50% cannabinoid solution in 50% MCT. After making these selections the extract is mixed/dispensed into a container. A label describing the contents of the extract will be printed and provided to the user to label the container. The extract that the user designed will be automatically stored under that user's profile in the CED database for future selection. In another example, a user may access a social media site such as Facebook, MassRoots or the like and share extract recipes. The user may also access others' recipes from social media sites and have a local CED dispense a formulation that user wishes to try.

Custom preset mixed extracts may also be created and dispensed by the CED. A microprocessor control in the CED allows any combination of all the multiple ingredients stocked in the CED to be mixed in variable proportion to each other. Strain specific or other desirable extract formulations may be pre-programmed so that a plurality of standard extract formulations can be dispensed either “as programmed” or with additional customizations by the user. Examples of pre programmed flavor profiles include strain specific terpene profiles of various strains, known to those having skill in the art, such as, for example those found at: https://shop.greenhouseseeds.nl/strains-terpenes-profiles.html.

An automatic cleaning cycle, incorporated into the CED's vending cycle is also incorporated in some embodiments. A mixing manifold/mix nozzle may be incorporated that is first cleaned with an automatic clean cycle, or cleaned after each dispensing, or at certain fixed predetermined intervals. This purges any residual ingredients that may remain after extract dispensing or that may have leaked into the mixing manifold during the period between dispensing cycles. The clean cycle is effectuated with an appropriate solvent, such as, for example heated ethanol, and/or water with an effective cleaning solution suitable for cleaning the hydrophobic ingredients being used. A valve on the fluid transport system will divert cleaning solution to a drain or other suitable waste storage area during the cleaning cycle.

The CED may also be equipped to provide for automated cleaning of valves. Solenoid valves or other valves used in the construction of the CED may clog over time and may fail to open/close properly. One embodiment of the CED uses a periodic valve cleaning cycle which may be executed via software or through manual control at certain defined intervals based on events such as elapsed time, number of dispensing cycles or the like.

The CED may also provide a unique billing/customer interface that enables individual customers to create unique extract formulations and store their favorite formulations in a central database. Each CED may be connected to the central database via the internet. As each individual CED may be stocked with different ingredients, the user interface may display extract possibilities that can be made in the specific CED that the customer is using. Customers may give unique names to the extract formulations that they create and them submit them to the database to be tried and rated by other customers, and the CED may display the top rated/selling formulations. Users may also report the effects of various extracts so as to enable other users to select extract formulations that provide desired effects.

Features of the invention will now be described in further detail. Features described as being preferred in relation to one aspect of the invention apply mutatis mutandis to all other aspects, unless clearly stated otherwise.

The cannabinoids used as ingredients in the CED may be isolated using any methods known by those having skill in the art, including the use of hydrocarbon solvents and solventless extraction. Therefore in one embodiment the cannabinoids used as extract ingredients are produced by extraction of cannabis plant material with supercritical or subcritical CO2. In an alternative embodiment the cannabinoid ingredients are produced by extraction from plant material by volatilisation with a heated gas. In an alternative embodiment the cannabinoid ingredients are produced from plant material through the sequential processes of CO2 extraction followed by fractional distillation and/or preparative chromatography. In some embodiments, the cannabinoid extract ingredients contain all of the naturally occurring cannabinoids in the plant material. Alternatively, synthetic or highly purified isolates of the cannabinoids can be used.

### BRIEF DESCRIPTION OF THE DRAWINGS

FIG. 1 shows a schematic representation of the custom extract dispenser.

FIG. 2 shows schematic representations of the custom extract dispenser in a housing.

FIG. 3 shows additional detail of the schematic representation of the custom extract dispenser.

FIG. 4 shows examples of heating elements and mixing nozzles that may be used in the custom extract dispenser.

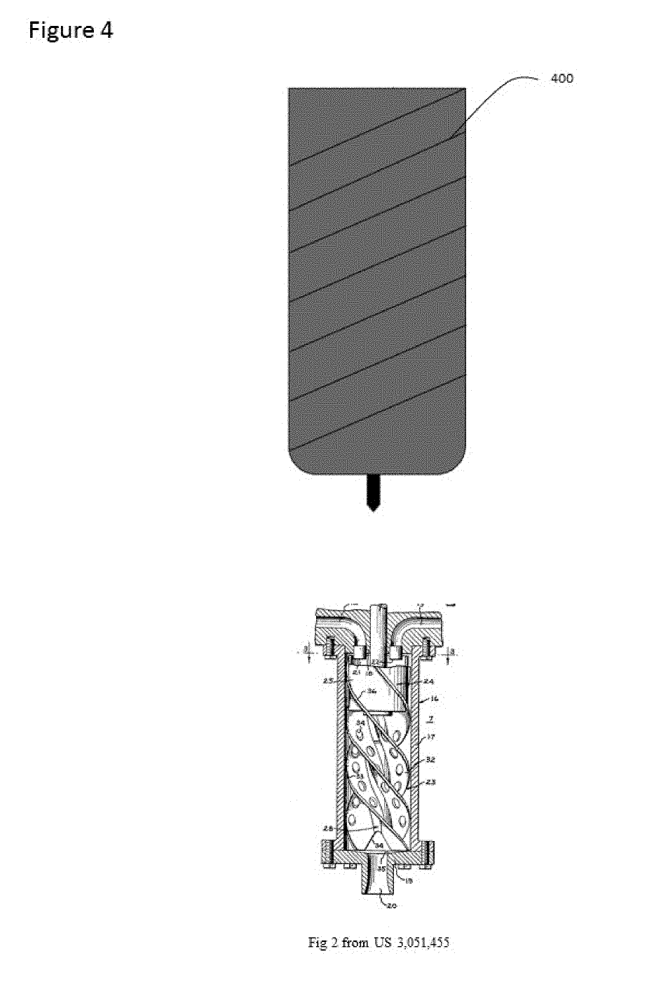

FIG. 5 shows an example of a Start Screen that will guide users through the operation of the custom extract dispenser.

FIG. 6 shows an example of an extract customization interface.

FIG. 7 shows an example of a summary screen that may be presented to users after they have customized an extract.

FIG. 8 shows an example of a visual depiction of the contents of a custom created extract.

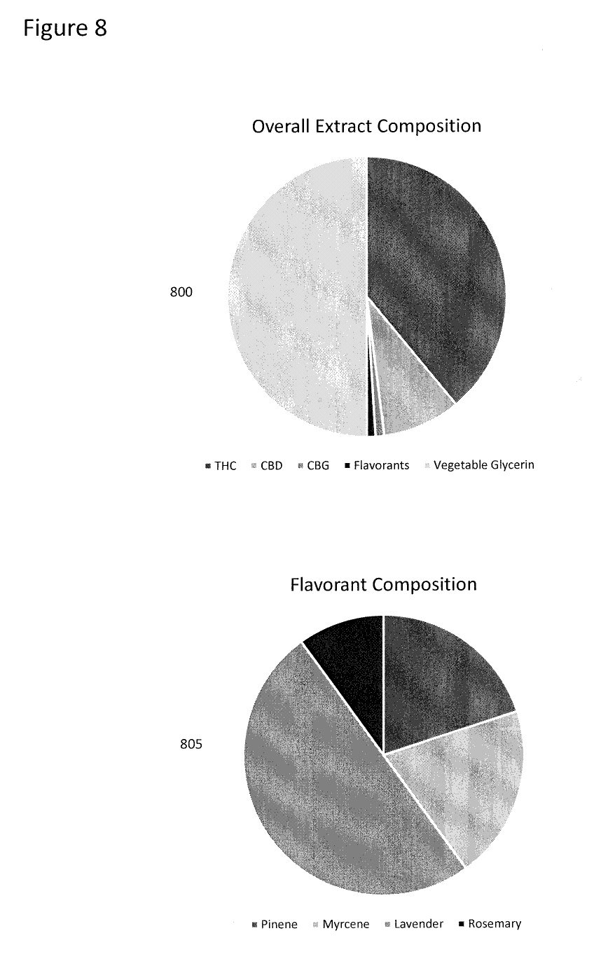

### DETAILED DESCRIPTION

These and other systems, methods, objects, features, and advantages of the present disclosure will be apparent to those skilled in the art from the following detailed description of the embodiments and drawings.

All documents mentioned herein are hereby incorporated in their entirety by reference. References to items in the singular should be understood to include items in the plural, and vise versa, unless explicitly stated otherwise or clear from the text. Grammatical conjunctions are intended to express any and all disjunctive and conjunctive combinations of conjoined clauses, sentences, words, and the like, unless otherwise stated or clear from context

The cannabinoids are a class of molecules primarily obtained through the extraction of cannabis plant material, although synthetic and/or bioreactor production may also be used. The various cannabinoids include tetrahydrocannabinol (THC), cannabidiol (CBD), (“the major cannabinoids”), tetrahydrocannabinolic acid (THCA), Cannabidiolic acid (CBDA), cannabinol (CBN), cannabigerol (CBG), cannabichromene (CBC), tetrahydrocannabivarin (THCV), and cannabidivarin (CBDV) as well as others (“the minor cannabinoids”). Various cannabinoids, used alone or in combination have shown a variety of significant biological effects including but not limited to pain relief, anti cancer, anti inflammatory, anti emetic, anti convulsant, and many others, including recreational effects.

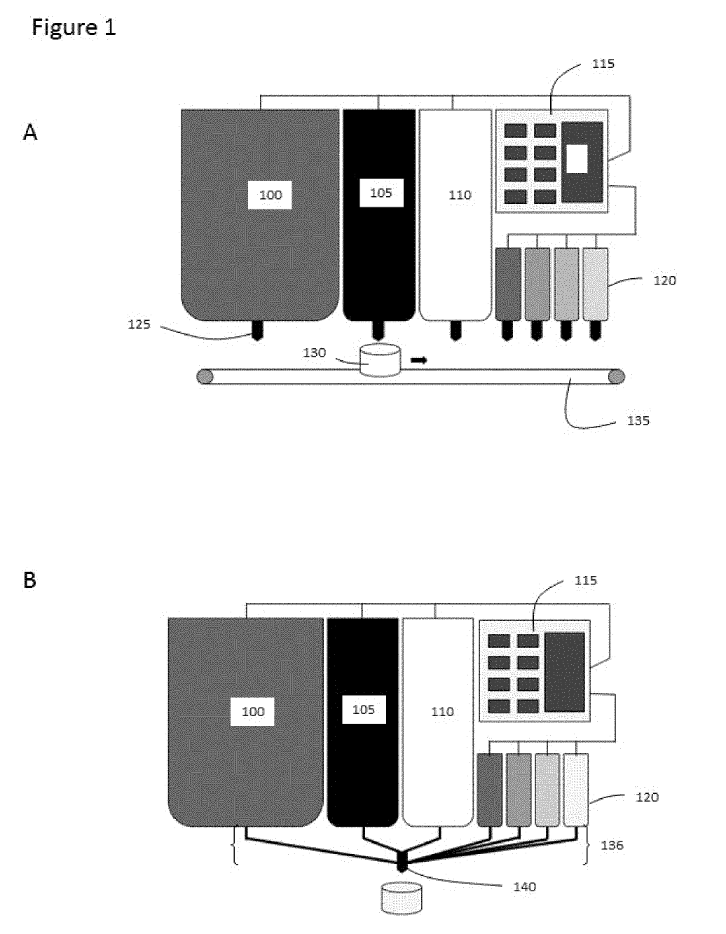

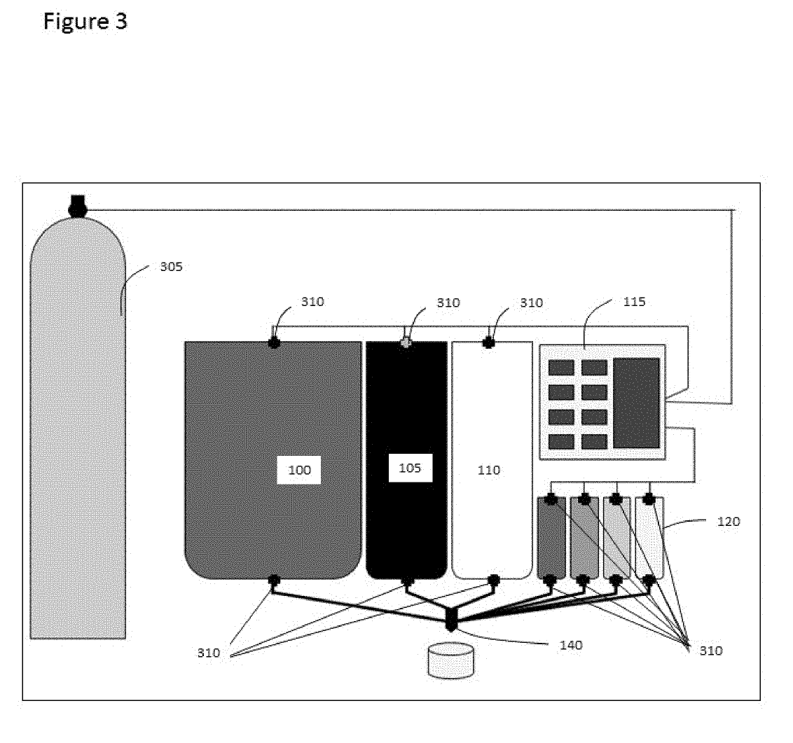

FIGS. 1-3 generally show implementations of CEDs and highlight the general construction of the devices. CEDs have a plurality of storage reservoirs for storing various extract ingredients (100, 105, 110, 120). The reservoirs may take any form known to those having skill in the art such as, for example, bottles and/or pressure vessels. The extract ingredients will usually include purified THC, purified CBD, purified minor cannabinoids, flavorants, and excipients/diluents. In some embodiments (FIG. 1A) each reservoir (100, 105, 110, 120) is operatively connected to a dispense nozzle (125) so that ingredient can be dispensed directly from the reservoir into a suitable container. In such embodiments, the ingredients are added in a stepwise fashion, and the container may move from one dispense nozzle to the next by way of a conveying means, such as a belt (135). In other embodiments (FIG. 1B) the various reservoirs are connected to a fluid transport system (136), such as for example a series of tubing or piping, that are in communication with a mixing manifold and/or a dispensing nozzle (140). The various reservoirs may be enclosed in a housing (205).

Compressed gas such as air or CO2 (305) may be operatively connected to the CED or incorporated therein to provide a driving force for fluid movement. Various valves such as solenoid valves (310) are in place to control fluid movement from the various reservoirs into the fluid transport system.

Because many of the cannabinoid ingredients, in particular purified cannabinoids and strain specific oils are very viscous at room temperature, heating means may be employed in some implementations to facilitate fluid movement. For example, the individual reservoirs may be wrapped with a heating element (400). In other implementations the piping/tubing (136) used to transport these ingredients is heated.

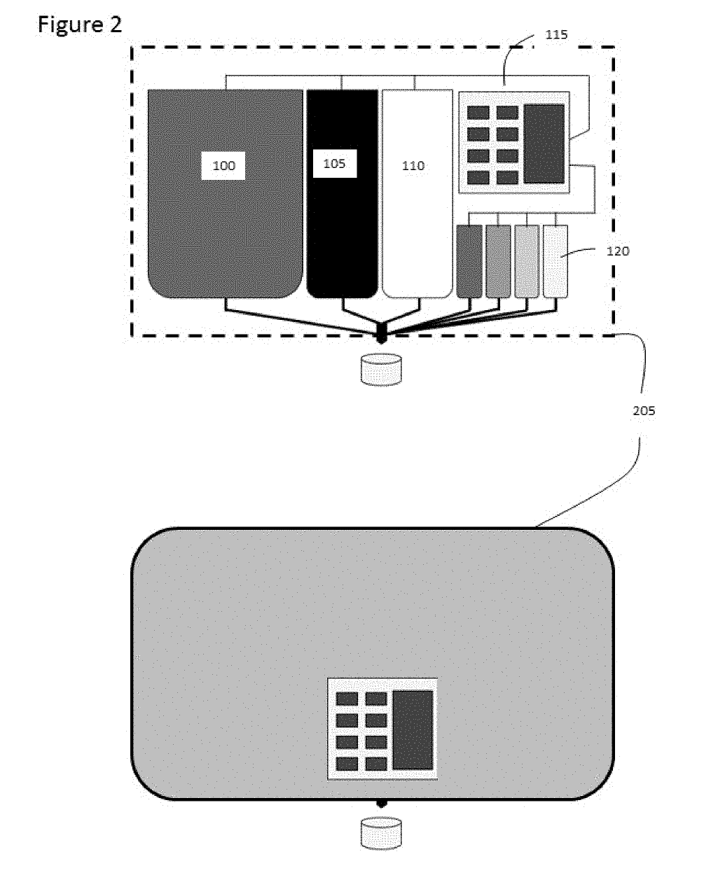

In order to provide a homogenous extract formulation to customers various mixing means may be employed at various points in the CED. For example, a mixing manifold in communication with the fluid transport system may be used to mix the various ingredients prior to dispensing. In other implementations, a mixing nozzle, such as the one shown in FIG. 2 from U.S. Pat. No. 3,051,455 may be used to mix the ingredients while they are being dispensed. These and other mixing means known to those having skill in the art may be used alone or in combination with each other to provide a well-mixed extract formulation to the user.

Because it is desirable to dispense accurate amounts of the various ingredients, fluid measurement means are incorporated in various implementations of the devices of the present invention. In some embodiments fluid measurement is effectuated using calibrated flow valves that open for a predetermined period of time based on the flow rate of the fluid through the valve. For example if the flow rate of a fluid through the valve is 60 ml/min, and the desired dispensing volume is 3 ml, the valve would open for 3 seconds. Alternatively, extract ingredients could be quantified by weight. In such embodiments, the container into which extract ingredients are to be dispensed would be placed on a balance in communication with the computing device in control of the fluid transportation system. Individual ingredients would be added in a stepwise fashion. For example a flow valve would open until a desired mass of a first ingredient is dispensed into a container at which point the flow valve would close. Additional ingredients would be added in the same fashion until all of the ingredients of the extract formulation were added to the container.

With respect to specific embodiments of the CED, some include a touch screen display (115), however other input means may be implemented such as keyboard/mouse, monitors, human-computer interface device, visual displays or combinations of the above. In an embodiment, a computing device containing at least one processor and memory communicates with the touch screen display to receive and transmit information related to the information acquired by the display and/or delivered by the computing device. The computing device converts the information input to a format suitable for communication with programmable logic controllers (“PLC”). Other embodiments may include a means to directly and/or indirectly communicate the user's input to the one or more controller devices.

The computing device communicates with the PLC via a suitable communications methodology such as, for example, via an Ethernet router. PLCs may send and receive information to and from the computing device which is related to the information retrieved by a user and/or the operation of the PLCs. By way of example, a user selects an option presented via the touchscreen on the CED which is then transmitted to the computing device (although in some embodiments the computing device and the touchscreen may be a combined unit). The computing device converts the user's input into a format suitable for communication with the PLCs to effectuate the user's desires.

In an implementation the PLC controls a relay connected to a solenoid valve to effectuate the controlled flow of fluid and/or gas through the solenoid manifold. Alternative implementations may include single or multiple relays of varying types including solid state relays, polarized relays, latching relays, reed relays, or other means to control or directly influence the actuation of a valve or the flow of fluid. Other implementations may also include single or multiple valves actuated by pneumatic, hydraulic, electrical, and/or other mechanical means. For example, the user's input after being communicated to the PLC via the computing device and/or Ethernet router may be effectuated by the activation of a relay which activates a solenoid valve allowing fluid to pass for an amount of time directly related to the user's input. Further, the user's input after being communicated to the PLC via the computing device and/or Ethernet router may be effectuated by the activation of a relay which activates the solenoid valve allowing fluid to pass for an amount of volume based on feedback from one or more flow sensors directly related to the user's input.

An embodiment utilizes a fluid system to effectuate the transportation and/or manipulation of one or more fluids and its properties. Various valves positioned at appropriate locations within the fluid system allow the flow of fluid to be terminated at any time.

An embodiment utilizes a pressurized gas tank, such as, for example pressurized air or CO2 to provide a driving force for the fluids through the fluid transportation system. For example, CO2 gas may actuate a pneumatic turbine pump which delivers positive pressure to fluid thus causing the fluid to traverse an outflow fluid path.

Pneumatically driven product pumps may effectuate the transmission of product fluid from one or more containers into a fluid transportation system. Alternative embodiments may utilize other means for the transmission of fluid such as, alone or in combination, electric pumps, pneumatic pumps, positive displacement pumps, hydraulic pumps, positive head, peristaltic pumps, and/or other devices known to those having skill in the art.

One embodiment may utilize a combination of solenoid manifolds to control the flow of fluid from unique and separate inflow paths to a common outflow path. For example, a six line manifold may contain six normally closed solenoid valves, each preventing a given fluid from entering the manifold. When a given solenoid valve is energized, fluid that was previously blocked by the solenoid flows through the manifold. Multiple solenoid valves may actuate during overlapping time intervals allowing one or more fluids to enter the manifold through unique fluid paths and depart through a common path. Other means may also be used to achieve the controlled flow of single and/or multiple fluids through a common exit may also be utilized.

In another implementation, the CED may utilize a normally open 3-way solenoid valve to control the flow of fluid to the dispense nozzle. The solenoid functions such that all fluid passing through an inlet departs through one of two unique outlet paths. When the 3-way solenoid is energized all fluid passing through an inlet departs through an outlet path connected to the dispense nozzle. Other implementations may utilize methods such as a normally closed solenoid or other means by which to control the dispensing of a fluid. In some embodiments the dispense nozzle may be a nozzle designed to mix the cannabis extract formulation as it is dispensed. Mixing nozzles are known to those having skill in the art. An example is the nozzle described in U.S. Pat. No. 3,051,455 hereby incorporated by reference.

A magnetic stripe card reader may effectuate the transfer of funds from the consumer as payment for products delivered by the invention. For example, consumer approaches the invention and utilizes a VISA® credit card to purchase a cannabis extract from the CED. Other means may also be used to effectuate a payment, such as a cash and coin machine or other payment accepting device.

A lockout feature may also be implemented in some embodiments, in particular in areas where registration is required before the purchase of cannabis based products can be made. In such cases, a card reader capable of reading cannabis registration cards may be incorporated into the device such that the CED would not be operable until the user's registration is validated. The lockout feature may also be implemented so as to allow human intervention, such as, for example, by manually or automatically updating a user registry that coincides with a user registry of approved cannabis customers or having an operator verify a user's registration status.

A near field radio frequency identification (RFID) reader may effectuate the recognition of a known customer and enable the invention to respond to that customer in a personalized manner. For example, a customer approaches the CED and presents an RFID tag to the reader which accepts an identification number from the customer's tag and transmits the information to a program which retrieves and utilizes information associated with the customer's identification number. The RFID tag may be a proximity card, a passive RFID tag, an active RFID tag, a Near Field Communications device, or any another RFID technology and/or frequency communication device suitable for effectuating the recognition of a known customer and enable the invention to respond to that customer in a personalized manner. Other implementations may use methods such as a user name, password, magnetic stripe card, smart card, and/or any similar method to effectuate the identification of known customers.

Single or multiple LED lights may be used to illuminate a cannabis extract container located below the dispense nozzle and or for the purpose of illumination in the area where fluid is dispensed.

The cannabis extract selection and customization process may utilize a touch screen display to effectuate communication between the CED and a user. Such communication enables the user to directly control the composition of a dispensed cannabis extract.

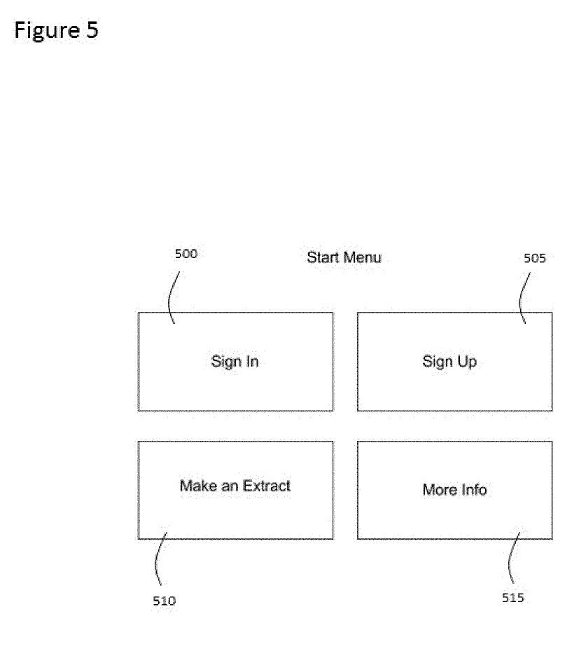

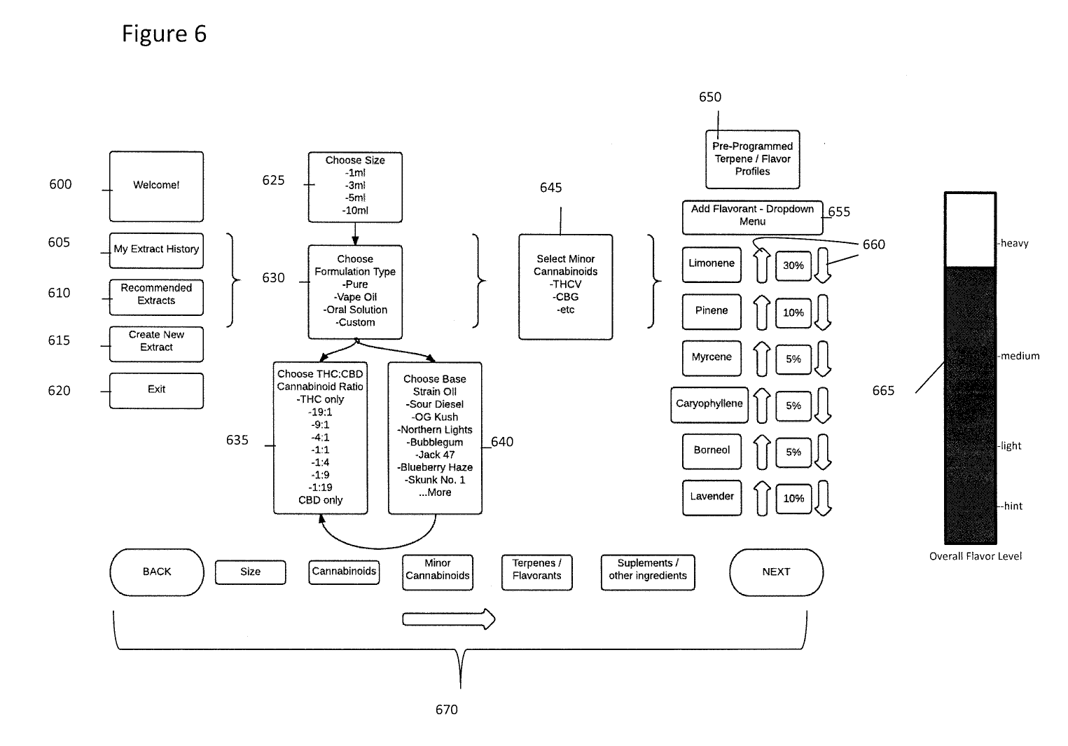

An implementation may use display images such as shown in FIG. 5-7 for the extract customization process. For example, a user utilizes a display image such as shown in FIG. 6 to select an extract volume. In one implementation, an extract volume may range from about 1 gram to about 10 grams or any similar volume related to a user's extract needs. In implementations where the CED is used to formulate bulk volumes of extract, significantly larger volumes may be used, such as, for example from about 500 g to 5 kg. The user then has the option to select a main extract type, such as a pure extract (pure in this case refers to an extract that is free from excipients/diluents) or a formulation suitable for use as an oil for vaporization, cooking or the like, an oral solution, or other custom blend. After that the users have the option to select whether they would like a purified cannabinoid based formulation (purified THC and/or CBD at a selected ratio) or a strain specific oil based formulation. Generally speaking, a strain specific oil based formulation will start with a whole plant extract from a particular cannabis varietal and will contain all of the major and minor cannabinoids present in that strain as well as any volatile compounds that survive the extraction process. Regardless of whether users select a purified cannabinoid based extract or a strain specific oil based extract, users will have the option to further customize their extract. Of particular note is that in the case where users select a strain specific oil based extract, users will have the option to add additional THC and/or CBD to that strain specific oil base. After extract base selection, a display screen, such as shown in FIG. 5, may be used to allow the user to select one or multiple minor cannabinoids to add to the extract. In situations where purified minor cannabinoids are generally not desired or where there is difficulty obtaining suitable purified stocks of minor cannabinoids, this step may be left out. After that, users will have the option to add flavorants to the extract. While it is recognized that terpenes, terpinoids and other volatile compounds found in cannabis are bioactive, for the purposes of this disclosure, they are referred to collectively as flavorants. Additional flavorants, may also be included as options including fruit flavors, other botanical based flavorants (lavender, eucalyptus, basil, rosemary, mint, menthol, and the like). For example, the user selects limonene, pinene and rosemary essential oil flavorants to be added to the custom extract. The user then has the option to customize the ratio in which the supplemental flavorants are added. The user may designate that the final combination of supplemental flavorant contain 20% limonene, 40% pinene, and 40% rosemary flavors. In addition to the ratio of flavorants, users may also select the overall flavorant level. For example a slider element on the user interface allows users to indicate the desired flavor level present in the extract. In an embodiment the slider has a scale from “hint” to “heavy.”

FIG. 5 shows an example of a start screen that will be presented to a user of the CED. When presented with the start menu, the user will have the opportunity to take several actions using the touch screen interface. The options include “sign in” (500) which will allow returning customers to access their account; “sign up” (505) which will allow new users to create an account; “make an extract” (510) which will enable users to access the CED without signing in/up; and “more info” (515) which will enable users to access instructions and other useful information about the system.

FIG. 6 shows an example of an embodiment of an interface screen that enables a user to create and/or customize an extract as well as access other useful information. “My Extract History” (605) will take the user to a history of the extracts they have previously purchased to facilitate easy re-ordering. “Recommended Extracts” (610) will show the user recommendations based on their past purchases. “Create New Extract” (615) will take the user to the screen shown to enable them to create a custom extract. “Exit” (620) will exit the system. When creating or customizing an extract, the user will select what quantity of extract is desired using the “choose size” input field (625). The user can then select the “formulation type” (630) using that input field. The user will then select the THC to CBD ratio using the ratio input field (635) and choose the base for their extract using the “choose base” input field (640). The user can then select whether to add minor cannabinoids using the “select minor cannabinoids” input field (645). The user will then move on to customizing the flavor profile of their extract using the flavor selection/alteration input fields (650, 655, 660) The user may choose pre programmed profiles (650), and/or add flavors (650). Once the flavors are selected, the individual components can be increased or decreased using the flavor level arrows (660). The flavor level arrows enable the user to increase/decrease the relative levels of a specific flavorant. Once the flavor profile is selected and adjusted, the user can adjust the overall level of flavor using the “overall flavor level” slider (665). The overall progress of the extract customization process is shown by the progress bar (670). Interacting with the touchscreen may, in some embodiments, take the user to additional screens for selecting additional options associated with the characteristic they are selecting.

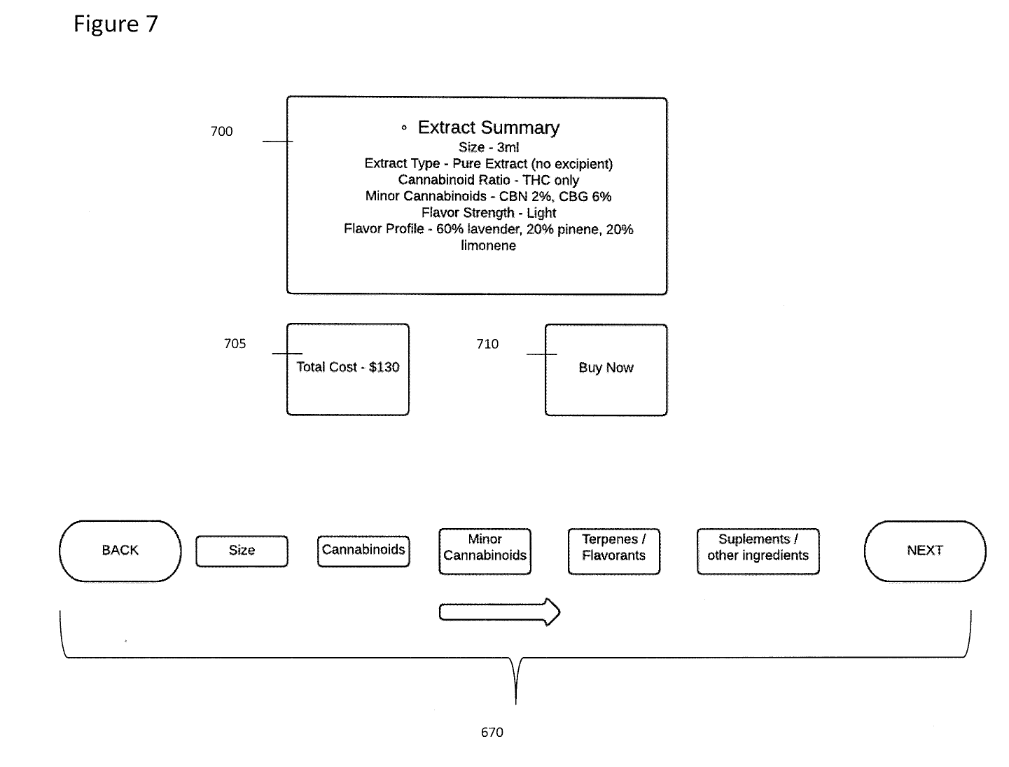

FIG. 7 shows a summary screen that will be presented to the user when the customization process is completed. An Extract Summary (705) will show the user a summary of the extract they selected and will print out and serve as the label for the extract once it is dispensed. A Total Cost (705) icon will show the user the cost of the extract they selected. A Buy Now (710) icon will enable the user to select to purchase the extract they selected.

With respect to the types of extracts/products dispensed by the CED, the inventors contemplate that the CED could be used to dispense a variety of cannabinoid containing products. As such the term “extract” with reference to the Cannabis Extract Dispenser should be given broad interpretation. It is contemplated that in various embodiments the CED may be used to dispense, extracts for vaporization, oral solutions and/or tinctures, topical formulations, beverages, oils for use in cooking/baking, and the like.

Other implementations may include similar but different means for the user to customize the specific flavorants to be added to the extract. For example, a user may choose to create an extract with multiple flavorants at an infinite variety of ratios with the sum total equaling one or 100%. The arbitrary value of 100% may be associated with a value directly related to the user's desired flavor strength. If a user chooses five flavorants at a flavor strength of “heavy,” were heavy flavoring is known to be equal to 1% of the total dispensed extract volume, then the five flavorants may be combined at an infinite variety of ratios with the volume equal to a constant of 1% of the dispensed extract volume. Still other implementations may utilize means other than a total volume approach to enable a user to customize the mix ratios of flavorants. Another implementation may be to set flavorant volumes to static volumes or “units.” The units may be of the same volume for an 1 ml extract and a 10 ml extract, or the volumes of the units may vary in proportion to the volume of extract selected. A user may select one unit or more than one.

After selecting flavorants in a unique combination as per the user's desire, nutritional supplements or other ingredients may be added to the extract through a display image on the user input interface. Of particular utility are those nutritional supplements and other ingredients that are hydrophobic in nature.

After the final contents of the desired extract are input, the user has the option to confirm the purchase and/or check the final composition of the created extract. The user may be presented with a visual image, such as, for example a pie chart that visually depicts the contents of the extract both in terms of its overall make up (800) and more specifically, the flavor profile of the extract (805).

At this point in the extract customization process, the user has the option to confirm the purchase and/or final composition of the custom extract. The user may also be presented with a display screen, that presents various information to the user. This information may include advertisements and/or instructions/warnings which are presented to the user. These advertisements may be generic and/or targeted to the specific users. The display screen may also present social media interaction options. For example, users may choose to share their extract with their friends as their Facebook®, status. Also, the final screen may allow the user to initiate the vending by pressing a button or through similar means of actuation.

A container dispenser may automatically place a container of suitable size to accommodate the selected extract volume in the dispense area. Alternatively, manual placement of suitable containers may be effectuated in some embodiments. The containers may be jars or other suitably sized vessels to accommodate the amount of the final dispensed formulation. In some embodiments the formulations may be dispensed directly into customers vaporizers, cartridges adapted for use in vaporizers, or a container that is adapted to integrate into a vaporizer.

Once dispensed, the CED, in some embodiments will print a label to be associated with the dispensed extract. The label will typically comprise the title of the extract, if one exists, the ingredients, proportions, and amounts of each ingredient as well as warning labels and/or other language required by law to accompany cannabis products. In some embodiments the label will be automatically applied by the CED or printed directly onto the container.

A cleaning cycle may be utilized to ensure proper sanitization and performance. In one implementation, the CED may utilize an automated cycle to effectuate the cleaning and sterilization of one or more fluid paths. This cleaning may be effectuated by the circulation of hot ethanol and/or a hot aqueous solution further comprising a cleansing fluid suitable for dissolving hydrophobic fluids through one or more of the fluid paths. Other implementations may utilize a similar cleaning cycle effectuated through manual means rather than automated. Also, various methods for determining the necessity of cleaning and sanitization may be incorporated to initiate a cleaning cycle. Such methods may include the use of a flow characterization sensor to sense a change in the flow indicative of the necessity for a cleaning cycle. However, other implementations may utilize methods dictating a time interval between cleaning cycles and/or a means for manual determination of the necessity of a cleaning cycle.

A computing device which includes a process and memory, such as random access memory (RAM), may be utilized. The computing device may be used in combination with other components of an implementation including, but not limited, to a controller and display device. The computing device may operate in combination with connected devices to effectuate the dispensing of a customized cannabis extract. The computing device may also perform actions according to software operating in the device.

A means to clean and sanitize components exposed to a user interacting with the CED for the purpose of extract vending may also be included. All surfaces exposed to the user are easily sanitized and cleaned. More specifically, areas of the CED exposed to fluid through the extract dispensing process, hereinafter called the dispense area, are regularly sanitized through a sanitization cycle. In one implementation, the cycle may include an ultra violet (UV) sanitization light to effectuate the sanitization of the dispense area. Other implementations may utilize hot fluid, such as water, at a temperature of approximately 190.degree.F. and/or sanitization fluid such as a bleach solution to effectuate the cleaning of the dispense area. One implementation may activate a UV light after the vending cycle or at some other time for a period necessary to inhibit bacterial growth and that of potential pathogens in the dispense area. In another implementation, a surface in the dispense area may be immersed in sanitization solution to effectuate the removal of harmful bacteria from the dispense area.

A method to verify the presence of a container in the dispense area may also be incorporated. Such a method allows for the CED to terminate dispense of extract in the event that there is no container present into which extract will be dispensed. One implementation may use an ultrasonic range finder to verify the presence of an object in the dispense area. Other implementations may use various other means to verify the presence of a container into which extract will be dispensed.

A method to store information on a customer identification device may also be incorporated. In one implementation, the device is a customer's near field radio frequency identification (RFID) tag. In other implementations the device may present itself as a personal communication or entertainment device such as an MP3 player or mobile device. Still other implementations may utilize various other devices capable of passing and storing information.

In one implementation, information containing information specific to the owner of the device, is sent from the CED to the device for storage. This information is then stored for later use by a user and/or the CED. For example, a customer possesses an RFID tag which stores information pertaining to the customer's account balance and extract preferences. In the event that the customer utilizes the RFID device to identify himself to the CED, the information previously described, is passed to the CED. The information is then utilized to effectuate the personalization and/or extract dispensing experience of the customer. Other implementations may utilize stored information for other purposes relating to the customer experience.

A method which enables customers to create or modify an aspect of their account and/or view information pertaining to the CED through electronic means may be incorporated. In one implementation, this is effectuated through the utilization of an electronic application (or “app”) such as an iPhone® application. Android® application and/or other electronic application. For example, a customer uses an iPhone® application to create a custom extract and add it to his or her account. The next time this customer identifies himself to an implementation of the CED, he may be given the option of dispensing the extract created on the application. In another example, a customer utilizes an iPhone® application to view locations of the CEDs near that specific customer's location. Other implementations may utilize various other electronic means to effectuate this method. Such other electronic means may include a web site, a social media outlet (e.g. Massroots®) or other information conduit. In other implementations, a user may use an app to create a custom extract to be dispensed at a remote location and have the extract delivered.

A method to present advertisements to one or more users within a given proximity may also be incorporated. The advertisements may be tailored to a specific user and/or intended for a general audience.

A method to store customer information in a database may also be incorporated. The database may be utilized by various implementations of the CED to share and retain information pertaining to a customer, extract components, location and various other information that are utilized to effectuate the extract customization, vending process, and/or customer experience. For example, a database contains information pertaining to volumes of extract ingredients to ensure that the ingredients are replaced before they empty. In another implementation, the database contains information pertaining to an individual customer's name, extract history, extract preferences, affiliations, age, gender, location and other personal attributes. This information is passed from the database to an implementation in the event that a customer identifies himself. The information may be utilized to customize the customer experience and present the customer with known preferences.

Data collected may also be used to ascertain the effect profiles of various extracts dispensed via the CED, be they pre-programmed extracts or fully custom extracts. Users may be presented with data collection instruments such as surveys and the like to collect data about the effects of extracts. Collected data on given extracts may be used to create extract recommendations. For example, a group of users may have reported a particular extract to be beneficial for back pain. Analysis of the collected data would reveal this trend and that extract may be tagged with a ‘back pain’ tag to indicate that other users have found this extract useful for that indication. Effects that may be queried include, but are not limited to, the group of effects known to be caused by cannabinoids to those having skill in the art. Surveys may be distributed remotely to users' mobile devices at fixed intervals following the dispensing of an extract.

While the present disclosure includes many embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

With respect to the above, it is to be understood that the invention is not limited in its application to the details of construction and to the arrangement of the components listed or the steps set forth in the description or illustrated in the drawings. The various apparatus and methods of the disclosed invention are capable of other embodiments, and of being practiced and carried out in various ways that would be readily known to those skilled in the art, given the present disclosure. Further, the terms and phrases used herein are for descriptive purposes and should not be construed as in any way limiting.

As such, those skilled in the art will appreciate that the conception upon which this disclosure is based may be utilized as a basis for designing other inventions with similar properties. It is important therefore that the embodiments, objects, and claims herein, be regarded as including such equivalent construction and methodology insofar as they do not depart from the spirit and scope of the present invention.

What is claimed is:

1. A cannabis extract dispenser comprising:
A plurality of reservoirs holding separate ingredients to be used in extract formulations;
a processor to control mixing any combination of the plurality of separate ingredients, the processor being adapted to customize a cannabis extract formulation by controlling the mixing of combinations and amounts of the plurality of separate ingredients based on a user's input;
wherein the processor regulates the mixing based on user preferences to mix a customized cannabis extract formulation from the separate ingredients held within the plurality of reservoirs, wherein the customized cannabis extract formulation comprises one or more ingredients selected from the group consisting of the major cannabinoids, the minor cannabinoids, terpenes, terpenoids, flavorants, and supplements held within the plurality of reservoirs; and
a dispensing nozzle in communication with the plurality of reservoirs to dispense the customized extract.
